(19) United States
(12) Patent Application Publication
(10) Pub. No.: US 2024/0196491 A1
(43) Pub. Date: Jun. 13, 2024

(54) LED LIGHTING CIRCUIT

(71) Applicant: KUM KYEONG LIGHTING Co., Ltd., Busan (KR)

(72) Inventor: Dong Wook LEE, Busan (KR)

(21) Appl. No.: 18/503,446

(22) Filed: Nov. 7, 2023

(30) Foreign Application Priority Data
Dec. 12, 2022 (KR) 10-2022-0172937

(51) Int. Cl. H05B 45/325; H05B 45/50

(52) U.S. Cl. CPC H05B 45/325; H05B 45/50

(57) ABSTRACT

The present invention relates to an LED lighting circuit that receives feedback on the final voltage output applied to LEDs and performs PWM control to regulate current flowing through a transformer unit, rectifies voltage of a secondary side of the transformer unit, and smoothens power and blocks surges by an output-side smoothing and surge protection unit to supply to the LEDs. The LED lighting circuit generates output as a high signal or a low signal whenever a microcomputer is turned on/off, so that the capacitor smoothens power at a high output, and when the output is low, suppresses transient voltage to extend the lifespan of the smoothing capacitor.

### REFERENCE TO RELATED APPLICATIONS

This application claims the priority benefit of Korean Patent Application No. 10-2022-0172937 filed on Dec. 12, 2022, the entire contents of which are incorporated herein by reference.

### FIELD OF THE INVENTION

The present invention relates to an LED lighting circuit which includes a plurality of smoothing capacitors, which have the lifespan shorter than other circuit elements in the LED lighting circuit, wherein at the time of initial lighting, one of them operates for smoothing while the other operates for surge absorption, and at the time of subsequent lighting, the one previously used for smoothing operates for surge absorption and vice versa.

### BACKGROUND OF THE INVENTION

Korean Patent No. 10-2043715 (Title of the Invention: Power supply for LED street lights) (hereinafter, referred to as “conventional art”) discloses a power supply for LED street lights including a main capacitor and an auxiliary capacitor installed at an output terminal through which LED power is supplied such that the main capacitor and the auxiliary capacitor can be selectively used according to a dimming state and conditions of the capacitors, thereby realizing technology to maximize the lifespan of capacitors.

FIG. 1 is a schematic diagram illustrating the overall configuration of the conventional art.

The conventional art includes: a rectification unit 10 which rectifies AC power; a voltage division unit 11 which divides the rectified DC voltage; an inverting circuit 20 which dimming-controls the rectified DC power into AC power, and outputs the AC power; an output rectification unit 30 which rectifies the output from the inverting circuit 20; a smoothing unit 40 which includes a main capacitor (Cm) and an auxiliary capacitor (Cs) and smooths the power rectified by the output rectification unit 30; an LED 50 for irradiating light by the power passing through the smoothing unit 40; a ripple signal generation unit 60 which detects ripple by resistors installed at both ends of the LED 50 and generates a ripple signal when the ripple exceeds a predetermined value; a level input unit 71 which inputs the light level to determine the brightness of light of the LED 50; and a microprocessor 70 which selects either the main capacitor (Cm) or the auxiliary capacitor (Cs) based on a signal input from the level input unit 71 and the ripple signal generation unit 60 to operate the main capacitor (Cm) or the auxiliary capacitor (Cs).

However, the conventional LED lighting circuit has a disadvantage in that it requires a separate protection circuit to absorb surge voltage that could potentially damage LEDs due to very high voltage and current often occurring at the initial lighting when AC power is input.

Moreover, such a conventional art causes incomplete noise absorption when the service life of the main capacitor is almost ended, and at this time, because the auxiliary capacitor is used, the smoothing operation such as noise absorption is performed incompletely for a significant period of time before the auxiliary capacitor is utilized.

Furthermore, in the conventional art, after the lifespan of the main capacitor has ended, the auxiliary capacitor is used. However, if the auxiliary capacitor undergoes performance changes due to prolonged non-use, it may cause incomplete operation.

### SUMMARY OF THE INVENTION

Accordingly, the present invention has been made to solve the above-mentioned problems occurring in the prior arts, and it is an object of the present invention to provide an LED lighting circuit which includes a plurality of smoothing capacitors, wherein at the time of initial lighting, one of the plurality of smoothing capacitors operates as a smoothing capacitor while the other operates as a capacitor for surge absorption, and at the time of subsequent lighting, the one previously used for smoothing operates as a capacitor for surge absorption and vice versa, thereby not needing a separate circuit for surge absorption and preventing deterioration of the capacitors since the lifespans of the two smoothing capacitors match each other.

To accomplish the above object, according to the present invention, there is provided an LED lighting circuit, which controls current flowing in a transformer unit by performing PWM control based on feedback of a final output voltage applied to LEDs, and after rectifying the voltage on the secondary side of the transformer unit, smoothens a power supply and blocks surges through an output-side smoothing and surge protection unit to supply to the LEDs, including: a microcomputer alternately generating a high signal and a low signal, which are different outputs, at a third output pin and a fourth output pin each time IC power is applied; a third switching unit in which a third switching element, FET, is turned on when the third output pin of the microcomputer is the high signal to allow power to be smoothed by smoothing capacitors, and the FET is turned off when the third output pin is the low signal to clamp transient voltage inflowing into a transient voltage suppressor (TVS3); and a fourth switching unit in which a fourth switching element, FET, is turned on when the fourth output pin of the microcomputer is the high signal to allow power to be smoothed by the smoothing capacitors, and the FET is turned off when the fourth output pin is the low signal to clamp the transient voltage through a transient voltage suppressor (TVS4).

Moreover, a gate of the third switching element, FET, of the third switching unit is connected to the power supply (DC+) line through a resistor (SR2) and is connected to the third output pin of the microcomputer, a drain is connected to the power supply (DC+) line, and a source is connected to the power supply (DC+) through the transient voltage suppressor (TVS3) which is parallel-connected with a resistor (SR1), and is connected to a power supply (DC−) through the smoothing capacitors. A gate of the fourth switching element, FET, in the circuit of the fourth switching unit is connected to the power supply (DC+) line through a resistor (SR3) and is connected to the fourth output pin of the microcomputer, a drain is connected to the power supply (DC+) line, and a source is connected to the power supply (DC+) through the transient voltage suppressor (TVS4) which is parallel-connected with the resistor (SR4), and is connected to a power supply (DC−) through the smoothing capacitors.

Furthermore, the power input into a primary side of the transformer unit is smoothed and surge-protected by the input-side smoothing and surge protection unit, and is input into the primary side of the transformer through a capacitor after the smoothing and surge protection, wherein the input-side smoothing and surge protection unit includes: a microcomputer that alternately generates a high signal and a low signal at a first output pin and a second output pin each time IC power is applied; a first switching unit in which a first switching element, FET, is turned on when a first output pin of the microcomputer is the high signal to allow power to be smoothed by smoothing capacitors, and the FET is turned off when the first output pin is the low signal to clamp transient voltage inflowing into a transient voltage suppressor (TVS1); and a second switching unit in which a second switching element, FET, is turned on when a second output pin of the microcomputer is the high signal to allow power to be smoothed by the smoothing capacitors, and the FET is turned off when the second output pin is the low signal to clamp the transient voltage through a transient voltage suppressor (TVS2).

In addition, a gate of the first switching element, FET, of a circuit of the first switching unit is connected to the power supply (DC+) line through a resistor and is connected to the first output pin of the microcomputer, a drain is connected to the power supply (DC+) line, and a source is connected to the power supply (DC+) through a resistor (SR14) and the transient voltage suppressor (TVS1) which is parallel-connected with the resistor (SR14), and is connected to a power supply (DC−) through the smoothing capacitors. A gate of the second switching element, FET, in the circuit of the second switching unit is connected to the power supply (DC+) line through a resistor and is connected to the second output pin of the microcomputer, a drain is connected to the power supply (DC+) line, and a source is connected to the power supply (DC+) through the transient voltage suppressor (TVS2) which is parallel-connected with a resistor (SR17), and is connected to a power supply (DC−) through the smoothing capacitors.

According to the present invention, the smoothing and surge protection unit is installed on the input side, on the output side, or both of the input and output sides, thereby achieving both smoothing and surge protection. Furthermore, the smoothing and surge protection unit has two switching units, wherein at the time of initial lighting, one of the switching units is used for smoothing, and at the time of the subsequent lighting, the one previously used for smoothing is used as a capacitor connected for surge absorption, thereby significantly extending the lifespan of the capacitor.

In this manner, the present invention can extend the lifespan of the capacitors, which were still shorter than that of LEDs, thereby overcoming the problem of the conventional art that the capacitors are frequently replaced.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a schematic diagram illustrating the overall configuration of a conventional art; and

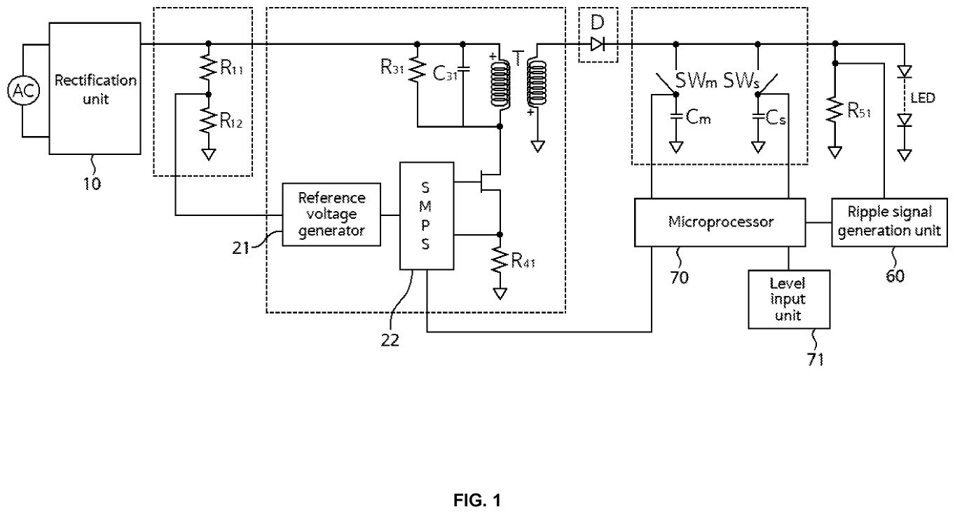

FIG. 2 is a circuit diagram explaining the overall configuration of the present invention.

### DETAILED DESCRIPTION OF THE INVENTION

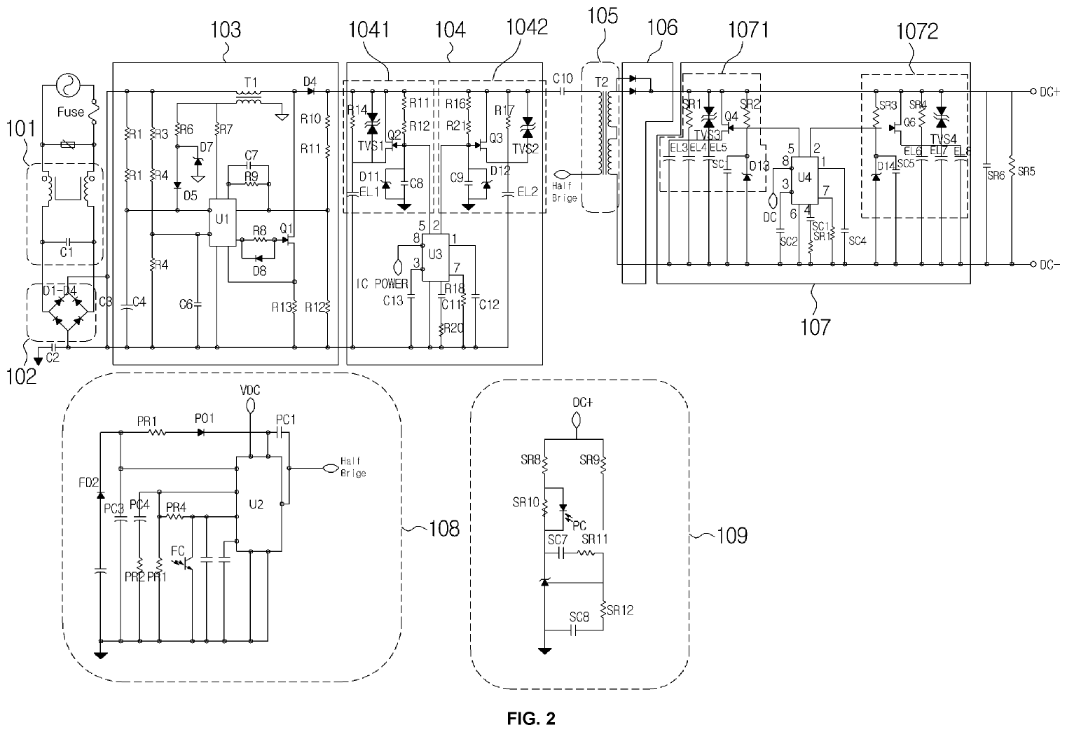

FIG. 2 is a circuit diagram explaining the overall configuration of the present invention.

A lighting circuit of the present invention includes: an EMI filter unit 101 for filtering noise inflowing from a power source (AC IN); a rectification unit 102 for rectifying the filtered power; a power factor improvement unit 103 performing a boost-up operation by a switching action of an inductor T1 and an FET Q1; an input-side smoothing and surge protection unit 104, which includes a first switching unit 1041 smoothing the power when a switching element Q2 is ON and blocking the surge of power when the switching element Q2 is OFF, and a second switching unit 1042, which has a switching element Q3 turning OFF when the switching element Q2 of the first switching unit 1041 is ON and turning ON when the switching element Q2 is OFF, and smoothens the power when the switching element Q3 is ON and blocks the surge of power when the switching element Q3 is OFF; a transformer unit 105 which steps down the high voltage inputted through the capacitor C10 to a low voltage; a rectification unit 106 which converts the stepped-down power through the transformer unit 105 into DC; an output-side smoothing and surge protection unit 107 including a third switching unit 1071, which the power when the switching element Q4 is ON and blocks the surge of power when the switching element Q4 is OFF, and a fourth switching unit 1072, which has a switching element Q6 turning OFF when the switching element Q4 of the third switching unit 1071 is ON, and turning ON when the switching element Q4 is OFF, and smoothens the power when the switching element Q6 is ON and blocks the surge of power when the switching element Q6 is OFF; a PWM control unit 108 connected to the end of a primary side of the transformer unit 105; and a feedback circuit unit 109 detecting the voltage of the output end of the illumination circuit and providing feedback to the PWM control unit 108 so that the PWM control unit 108 controls output consistently.

The embodiment of the present invention illustrated in FIG. 2 describes a so-called “two stage PFC” circuit where the PWM control unit and the power factor improvement unit of 50 watts or more are separately provided. However, the present invention is not limited thereto, and it is obvious that the invention can be equally applied to a so-called “one stage PFC” circuit where the power factor improvement unit and the PWM control unit for less than 50 watts are combined.

In a state in which abnormal voltage, such as surge, is primarily removed while passing through the EMI filter unit 101, the AC power is full-wave rectified in the rectification unit 102, and because the power factor of the full-wave rectified DC power considerably drops, the power factor is improved as passing through the power factor improvement unit 103.

The power factor improvement unit 103 operates centered around an inductor (T1) where a boost-up operation occurs due to a switching element FET Q1 operated by a PWM IC U1. Power factor improvement circuits based on the boost-up operation, such as that disclosed in Korean Patent No. 10-0247393 and other lots of literatures, is very common and already publicly known, so a detailed description thereof will be omitted.

The power with the improved power factor after passing through the power factor improvement unit 103 is smoothened and surge-protected while passing through the smoothing and surge protection unit 104.

The input-side smoothing and surge protection unit 104 includes: a microcomputer U3 having a first output pin 5 and a second output pin 2 which alternately generate a high signal H and a low signal L each time an IC power (IC POWER) with different outputs is applied to the two pins; a first switching unit 1041 where a first switching element FET Q2 turns ON when the first output pin 5 of the microcomputer U3 is the signal H to allow the DC power output from the power factor improvement unit to be smoothed by a capacitor EL1, and where the first switching element FET Q2 turns OFF when the first output pin 5 is the signal L to attenuate a transient voltage peak value introduced by a transient voltage suppressor TVS1 to block surges; and a second switching unit 1042 where a second switching element FET Q3 turns ON when the second output pin of the microcomputer U3 is the signal H to allow the DC power output from the power factor improvement unit to be smoothened by the capacitor EL2, and where the first switching element FET Q2 turns OFF when the second output pin is the signal L to block surges through a transient voltage suppressor TVS2.

The microcomputer U3 of the input-side smoothing and surge protection unit 104 stores and remembers the output signals of the first output pin 5 and the second output pin 2 in a non-volatile flash memory inside the microcomputer U3 while the AC power (AC IN) is supplied to the microcomputer U3. When the AC power is cut off, the IC power is turned off. Thereafter, power is subsequently supplied again to the IC power, the microcomputer reads the previous signal values stored in the flash memory and outputs output signals with numbers 5 and 2 as opposite values of the previous output values.

Furthermore, the outputs of the first output pin 5 and the second output pin 2 cannot simultaneously be either H or L due to an internal interlock circuit. Among the two output pins, one outputs as the signal H and the other as the signal L. These outputs are respectively input to gates of the FETs Q2 and Q3.

The gate of the FET Q2, which is a first switching element of the circuit of the first switching unit 1041 of the input-side smoothing and surge protection unit 104 is connected to the power (+) line through resistors R11 and R12, is grounded through a capacitor C8 that is parallel-connected with a Zener diode D11, connected to the first output pin 5 of the microcomputer U3 so that H or L output is input. A drain D of the FET Q2 is connected to the power (+) line, and a source S of the FET Q2 is connected to the power (+) through a resistor R14 and a transient voltage suppressor TVS1 that is parallel-connected with the resistor R14, is connected to the power (−) through the smoothing capacitor EL1.

Likewise, the gate of the FET Q3, which is a second switching element of the circuit of the second switching unit 1042 is connected to the power (+) line through resistors R16 and R21, is grounded through a capacitor C8 that is parallel-connected with a Zener diode D12, connected to the second output pin 2 of the microcomputer U3 so that H or L output is input. A drain D of the FET Q3 is connected to the power (+) line, and a source S of the FET Q3 is connected to the power (+) through a transient voltage suppressor TVS2 that is parallel-connected with a resistor R17, is connected to the power (−) through the smoothing capacitor EL1.

In the input-side smoothing and surge protection unit 104, when the signal H is output from the first output pin 5 of the microcomputer U3, the H signal is input to the gate of the FET Q2 of the first switching unit 1041, and since the signal L is output from the second output pin 2, the L signal is input to the gate of the FET Q3 of the second switching unit 1042.

Under the condition, the FET Q2 conducts, and the smoothing capacitor EL1 operate as being directly connected between the power lines (+) and (−), thereby smoothing and outputting the voltage applied to the power line. In this state, although the FET Q3 of the second switching unit 1042 is off, when a transient voltage exceeding a predetermined voltage of the transient voltage suppressor TVS2 is applied, the transient voltage is clamped and stabilized by the transient voltage suppressor TVS2.

Likewise, when the signal L is output from the first output pin 5, the signal L is input to the gate of the FET Q2 of the first switching unit 1041, and since the signal H is output from the second output pin 2, the signal H is input to the gate of the FET Q3 of the second switching unit 1042, so that the FET Q3 conducts, and the smoothing capacitor (EL2) operates as being directly connected between the power lines (+) and (−), thereby smoothing and outputting the voltage applied to the power line. Under the condition, although the FET Q2 of the first switching unit 1041 is off, when a transient voltage exceeding a predetermined voltage of the transient voltage suppressor TVS1 is applied, the transient voltage is clamped and stabilized.

In such a configuration, the input-side smoothing and surge protection unit 104 utilizes two smoothing capacitors EL1 and EL2, of which one is used for smoothing and the other is used for surge protection by being integrated with a transient voltage suppressor. Therefore, the input-side smoothing and surge protection unit can maximize the lifespan of the smoothing capacitor, which is significantly shorter than that of LEDs, and is very effective in prolonging the lifespan of LEDs since suppressing surges, specifically, transient voltage generated at the time of initial lighting.

The capacitor used for smoothing in the state in which AC power is initially applied is alternatingly used for transient voltage protection with very low frequency in a state in which the next AC power is applied, thereby enhancing the lifespan extension effect of the capacitor.

In addition, the power output from the input-side smoothing and surge protection unit 104 passes through the capacitor C10, is stepped down while passing through the transformer unit 105, and is rectified while passing through the secondary-side rectification unit 106.

The primary coil end of the transformer unit 105 has a PWM control unit 108 to control the size of power introduced into the transformer unit 105 so that final outputs DC+ and DC− can always maintain a constant voltage by a signal feedbacked by the feedback circuit unit 109.

In this instance, the PWM control unit 108 and the feedback circuit unit 109 are circuits commonly used in power circuits as described in this invention. The feedback circuit unit 109 generates light from a PC proportional to the final output voltage which is voltage of the output terminal of the present invention, and the PWM control unit 108 collects the light and centers around the microcomputer U2 controlling the pulse width to maintain a consistent final output voltage.

The power that has passed through the secondary-side rectification unit 106 is input into the output-side smoothing and surge protection unit 107, which performs the same role as the input-side smoothing and surge protection unit 104, to perform smoothing and protecting transient voltage or surges flowing into the power supply.

The output-side smoothing and surge protection unit 107 includes: a microcomputer U4 having a third output pin 5 and a fourth output pin 2 that alternately generate a high signal H and a low signal L at two output pins 3 and 7 each time the IC power is applied; a third switching unit 1071 where a third switching element FET Q4 turns ON when the third output pin 5 of the microcomputer U4 is the signal H to allow the output voltage of the rectification unit to be smoothed by capacitors EL3, EL4, and ELS, and where the third switching element FET Q4 turns OFF when the third output pin is the signal L to attenuate a transient voltage peak value introduced by a transient voltage suppressor TVS3 to block surges; and a fourth switching unit 1072 where a fourth switching element FET Q6 turns ON when the fourth output pin 2 of the microcomputer U4 is the signal H to allow the output voltage of the rectification unit to be smoothened by capacitors EL6, EL7 and EL8, and where the fourth switching element FET Q6 turns OFF when the fourth output pin is the signal L to clamp transient voltage by a transient voltage suppressor TVS4.

The operational characteristics and effects of the output-side smoothing and surge protection unit 107 are very similar to those of the input-side smoothing and surge protection unit 104, so when one switching device Q4 is in operation, the other switching device Q6 remains inactive. Therefore, the smoothing capacitors have a dramatically extended lifespan, and can block surges, thereby further extending the lifespan of LEDs.

What is claimed is:

1. An LED lighting circuit which controls current flowing in a transformer unit by performing PWM control based on feedback of a final output voltage applied to LEDs, and after rectifying the voltage on the secondary side of the transformer unit, smoothens a power supply and blocks surges through an output-side smoothing and surge protection unit to supply to the LEDs, comprising:
a microcomputer alternately generating a high signal and a low signal, which are different outputs, at a third output pin and a fourth output pin each time IC power is applied;
a third switching unit in which a third switching element, FET, is turned on when the third output pin of the microcomputer is the high signal to allow power to be smoothed by smoothing capacitors, and the FET is turned off when the third output pin is the low signal to clamp transient voltage inflowing into a transient voltage suppressor (TVS3); and
a fourth switching unit in which a fourth switching element, FET, is turned on when the fourth output pin of the microcomputer is the high signal to allow power to be smoothed by the smoothing capacitors, and the FET is turned off when the fourth output pin is the low signal to clamp the transient voltage through a transient voltage suppressor (TVS4).

2. The LED lighting circuit according to claim 1, wherein a gate of the third switching element, FET, of the third switching unit is connected to the power supply (DC+) line through a resistor (SR2) and is connected to the third output pin of the microcomputer, a drain is connected to the power supply (DC+) line, and a source is connected to the power supply (DC+) through the transient voltage suppressor (TVS3) which is parallel-connected with a resistor (SR1), and is connected to a power supply (DC−) through the smoothing capacitors, and
wherein a gate of the fourth switching element, FET, in the circuit of the fourth switching unit is connected to the power supply (DC+) line through a resistor (SR3) and is connected to the fourth output pin of the microcomputer, a drain is connected to the power supply (DC+) line, and a source is connected to the power supply (DC+) through the transient voltage suppressor (TVS4) which is parallel-connected with the resistor (SR4), and is connected to a power supply (DC−) through the smoothing capacitors.

3. The LED lighting circuit according to claim 1, wherein the power input into a primary side of the transformer unit is smoothed and surge-protected by the input-side smoothing and surge protection unit, and is input into the primary side of the transformer through a capacitor after the smoothing and surge protection, and
wherein the input-side smoothing and surge protection unit includes:
a microcomputer that alternately generates a high signal and a low signal at a first output pin and a second output pin each time IC power is applied;
a first switching unit in which a first switching element, FET, is turned on when a first output pin of the microcomputer is the high signal to allow power to be smoothed by smoothing capacitors, and the FET is turned off when the first output pin is the low signal to clamp transient voltage inflowing into a transient voltage suppressor (TVS1); and
a second switching unit in which a second switching element, FET, is turned on when a second output pin of the microcomputer is the high signal to allow power to be smoothed by the smoothing capacitors, and the FET is turned off when the second output pin is the low signal to clamp the transient voltage through a transient voltage suppressor (TVS2).

4. The LED lighting circuit according to claim 3, wherein a gate of the first switching element, FET, of a circuit of the first switching unit is connected to the power supply (DC+) line through a resistor and is connected to the first output pin of the microcomputer, a drain is connected to the power supply (DC+) line, and a source is connected to the power supply (DC+) through a resistor (SR14) and the transient voltage suppressor (TVS1) which is parallel-connected with the resistor (SR14), and is connected to a power supply (DC−) through the smoothing capacitors, and
wherein a gate of the second switching element, FET, in the circuit of the second switching unit is connected to the power supply (DC+) line through a resistor and is connected to the second output pin of the microcomputer, a drain is connected to the power supply (DC+) line, and a source is connected to the power supply (DC+) through the transient voltage suppressor (TVS2) which is parallel-connected with a resistor (SR17), and is connected to a power supply (DC−) through the smoothing capacitors.
